(19) United States
(12) Patent Application Publication
(10) Pub. No.: US 2021/0112411 A1
(43) Pub. Date: Apr. 15, 2021

(54) MULTI-FACTOR AUTHENTICATION IN PRIVATE MOBILE NETWORKS

(71) Applicant: Cisco Technology, Inc., San Jose, CA (US)

(72) Inventors: Rajesh S. Pazhyannur, Fremont, CA (US); Anand Oswal, Pleasanton, CA (US); Arun G. Khanna, Sunnyvale, CA (US)

(21) Appl. No.: 17/066,682

(22) Filed: Oct. 9, 2020

Related U.S. Application Data
(60) Provisional application No. 62/913,733, filed on Oct. 10, 2019.

(51) Int. Cl. H04W 12/06; H04W 12/00; H04L 29/06

(52) U.S. Cl. CPC H04W 12/0609; H04L 63/0853; H04L 63/0823; H04W 12/0023

(57) ABSTRACT

Systems and methods are provided for user equipment (UE) multi-factor authentication enrollment. An example method can include receiving, by a first mobile network, an authentication request from a UE; performing a first authentication of the UE at the first mobile network; based on a determination that the UE has not been onboarded at a second mobile network, initiating, by the first mobile network, enrollment of the UE with the second mobile network for additional authentication of the UE with the second mobile network, wherein the first mobile network is separate from the second mobile network; and after the enrollment of the UE with the second mobile network, coordinating, by the first mobile network, a second authentication of the UE with the second mobile network.

### CROSS-REFERENCE TO RELATED APPLICATIONS

The present application claims the benefit of, and priority to, U.S. Provisional Patent Application No. 62/913,733, filed on Oct. 10, 2019, entitled “METHODS TO USE MULTI-FACTOR AUTHENTICATION IN PRIVATE LTE/5G SYSTEMS”, the contents of which are expressly incorporated herein in their entirety and for all purposes.

### TECHNICAL FIELD

The present disclosure generally relates to computer networking and, more specifically, to multi-factor authentication in mobile network environments including public and private mobile networks.

### BACKGROUND

Mobile networks, such as cellular telecommunication networks (e.g., Long Term Evolution (LTE), Global System for Mobile Communications (GSM), fourth generation (4G) networks, fifth generation (5G) networks, etc.), allow users to obtain wireless network connectivity and data from a wide array of mobile devices. For example, mobile networks allow users to obtain wireless network connectivity and data from personal computers, smartphones, smart wearable devices (e.g., smart watches, smart glasses, head-mounted displays, etc.), camera systems, game systems, cellular phones, and Internet-of-Things (IoT) devices, among others. Mobile networks can include public mobile networks owned and/or operated by service providers and network operators.

A mobile network can also include one or more private mobile networks owned and/or operated by one or more private entities, such as enterprises. For example, a private entity can operate a private mobile network that connects to, interacts with, and/or is part of, a public mobile network. In such cases, the private entity that operates the private mobile network has little to no control over the device authentication process. Accordingly, to allow mobile devices to access the private mobile network, the private entity typically relies on the public mobile network to ensure mobile devices connecting to the private mobile network are properly authenticated. However, without a reliable way to verify that mobile devices connecting to the private mobile network are properly authorized and authenticated, the private entity risks exposing the private mobile network and associated data to unauthorized users and devices.

### BRIEF DESCRIPTION OF THE FIGURES

In order to describe the manner in which the various advantages and features of the disclosure can be obtained, a more particular description of the principles described above will be rendered by reference to specific embodiments thereof, which are illustrated in the appended drawings. Understanding that these drawings depict only example embodiments of the disclosure and are not to be considered to limit its scope, the principles herein are described and explained with additional specificity and detail through the use of the drawings in which:

FIG. 1 is a diagram of a communication system illustrating an example network environment, in accordance with some examples of the present disclosure;

FIG. 2 is a diagram illustrating an example flow for device multi-factor authentication enrollment, in accordance with some examples of the present disclosure;

FIG. 3 is a diagram illustrating another example flow for UE multi-factor authentication enrollment in a mobile network environment including a public 5G network and a private mobile network, in accordance with some examples of the present disclosure;

FIG. 4 is a diagram illustrating an example flow for multi-factor authentication of a user equipment in a public mobile network and a private mobile network, in accordance with some examples of the present disclosure;

FIG. 5 is a diagram illustrating an example flow for multi-factor authentication of a user equipment in a network environment including a public 5G network and a private mobile network, in accordance with some examples of the present disclosure;

FIG. 6 is a flowchart illustrating an example method for device multi-factor authentication enrollment, in accordance with some examples of the present disclosure;

FIG. 7 is a flowchart illustrating another example method for device multi-factor authentication enrollment, in accordance with some examples of the present disclosure;

FIG. 8 illustrates an example network device, in accordance with some examples of the present disclosure; and

FIG. 9 illustrates an example computing device architecture, in accordance with some examples of the present disclosure.

### DESCRIPTION OF EXAMPLE EMBODIMENTS

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

### Overview

Systems and methods are provided for multi-factor authentication in private mobile networks. According to at least one example, a method is provided for multi-factor authentication in private mobile networks. The method can include receiving, by a first mobile network, an authentication request from a user equipment (UE); performing a first authentication of the UE at the first mobile network; based on a determination that the UE has not been onboarded at a second mobile network, initiating, by the first mobile network, enrollment of the UE with the second mobile network for additional authentication of the UE with the second mobile network, wherein the first mobile network is separate from the second mobile network; and after the enrollment of the UE with the second mobile network, coordinating, by the first mobile network, a second authentication of the UE with the second mobile network.

According to at least one example, a non-transitory computer-readable medium is provided for multi-factor authentication in private mobile networks. The non-transitory computer-readable medium can include instructions stored therein which, when executed by one or more processors, cause the one or more processors to receive, by a first mobile network, an authentication request from a user equipment (UE); perform a first authentication of the UE at the first mobile network; based on a determination that the UE has not been onboarded at a second mobile network, initiate, by the first mobile network, enrollment of the UE with the second mobile network for additional authentication of the UE with the second mobile network, wherein the first mobile network is separate from the second mobile network; and after the enrollment of the UE with the second mobile network, coordinate, by the first mobile network, a second authentication of the UE with the second mobile network.

According to at least one example, a system is provided for multi-factor authentication in private mobile networks. The apparatus can include a memory and one or more processors configured to receive, at a first mobile network, an authentication request from a user equipment (UE); perform a first authentication of the UE at the first mobile network; based on a determination that the UE has not been onboarded at a second mobile network, initiate, at the first mobile network, enrollment of the UE with the second mobile network for additional authentication of the UE with the second mobile network, wherein the first mobile network is separate from the second mobile network; and after the enrollment of the UE with the second mobile network, coordinate, by the first mobile network, a second authentication of the UE with the second mobile network.

In some aspects, the system, method and computer-readable medium described above can include sending, by the first mobile network to the second mobile network and in response to the authentication request, a request to check whether the UE has previously been onboarded at the second mobile network; receive, by the first mobile network, a first message indicating that the UE has not been onboarded at the second mobile network; and send, by the first mobile network to the UE, a second message triggering the enrollment of the UE with the second mobile network.

In some examples, initiating the enrollment of the UE with the second mobile network can include sending, by the first mobile network to the UE, a message triggering the UE to generate a certificate signing request (CSR) for the second mobile network using an embedded subscriber identity module (eSIM) associated with the UE.

In some aspects, the system, method and computer-readable medium described above can include coordinating the enrollment of the UE with the second mobile network. In some examples, coordinating the enrollment of the UE can include receiving, by the first mobile network from the UE, a certificate signing request (CSR) generated by the UE using an embedded subscriber identity module (eSIM); and forwarding, by the first mobile network to the second mobile network, the CSR from the UE.

In some cases, coordinating the enrollment of the UE can include receiving, by the first mobile network from the second mobile network, a signed certificate associated with the CSR from the UE; and forwarding, by the first mobile network, the signed certificate to the UE. In some examples, coordinating the second authentication of the UE with the second mobile network can include sending, by the first mobile network to the second mobile network, a message including an identity associated with the UE, the message being sent after the UE has been authenticated at the first mobile network; forwarding, by the first mobile network to the second mobile network, a certificate signing request (CSR) generated by the UE using an embedded subscriber identity module (eSIM); and forwarding, by the first mobile network to the UE, a signed certificate from the second mobile network, the signed certificate being associated with the CSR.

In some aspects, the system, method and computer-readable medium described above can include receiving, by the first mobile network, a registration request from the UE; authenticating the UE at the first mobile network; determining that the UE has been onboarded at the second mobile network, the UE being onboarded based on the enrollment of the UE with the second mobile network; and based on the UE being onboarded at the second mobile network, coordinating, by the first mobile network, a separate authentication of the UE with the second mobile network.

In some cases, coordinating the separate authentication of the UE can include obtaining an identity associated with the UE and sending the identity to the second mobile network.

In some cases, the first mobile network can include a public mobile network and the second mobile network can include a private mobile network. In some examples, the first mobile network and the second mobile network can implement different authentication domains and/or different authentication management systems.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### EXAMPLE EMBODIMENTS

Before a mobile device connects to a computer network, the mobile device may often go through an onboarding process that can involve the network enrolling the device in the network, authenticating the device (and/or a user of the device) and/or authorizing access by the device (and/or user of the device) to the network (and/or a segment of the network). In many cases, access to the network can depend on one or more factors such as, for example and without limitation, the rights or privileges of the user and/or device, the type of device, a specific identity of the device, specific access policies, and/or other access/security criteria.

In some examples, authentication can include an exchange of information known between the device and the network (or authentication system(s)), such as a password, key, and verifiable information associated with the device such as a certificate or a Subscriber Identity Module (SIM), among others. For example, a mobile device can be authenticated based on information unique to the mobile device, such as a SIM. A SIM can be removable from the device (e.g., a SIM card), or affixed to (and/or programmed on) the device (e.g., an embedded SIM or eSIM).

In some cases, a mobile device can use an operational user profile to access a private network. For example, a mobile device can use an operational user profile deployed in a SIM by a provisioning system associated with the private network. In some cases, the provisioning system (e.g., a Subscription Management Data Preparation (SM-DP) platform, etc.) can be accessed via a side channel (e.g., a WIFI connection, a BLUETOOTH connection, a private mobile network or Citizen Broadband Radio Service, etc.) and/or a bootstrapping profile provided by network operator, such as a Mobile Network Operator (MNO). The bootstrapping profile may enable the mobile device to obtain a network address and contact a provisioning system, such as an SM-DP, associated with the private network, which can deploy an operational profile in the SIM of the mobile device.

In certain mobile network systems, such as LTE and 5G systems, devices can be authenticated based on a credential in a SIM (e.g., in a Universal Integrated Circuit Card (UICC) or embedded UICC (eUICC) or any other SIM). These credentials are often used to authenticating devices in a public network. However, in a private mobile network, such as Citizen Broadband Radio Service (CBRS) network (e.g., a private Long Term Evolution (LTE) network, a 5G network, etc.), the devices given access to the private mobile network will often exchange traffic with other devices in the private mobile network. Without additional layers of authentication or control over the authentication process, the private mobile network can be exposed to potential attacks or unauthorized access and depend on a third-party to authenticate devices accessing resources on the private mobile network.

In some examples, the technologies disclosed herein can provide additional layers of authentication for devices accessing private mobile networks. For example, the technologies herein can provide a multi-factor authentication mechanism to allow private mobile network to authenticate devices connecting to the private mobile network and a public mobile network. The private mobile network can authenticate devices using an authentication procedure in addition to any authentication procedure performed by the devices when connecting to, and/or accessing, the public mobile network.

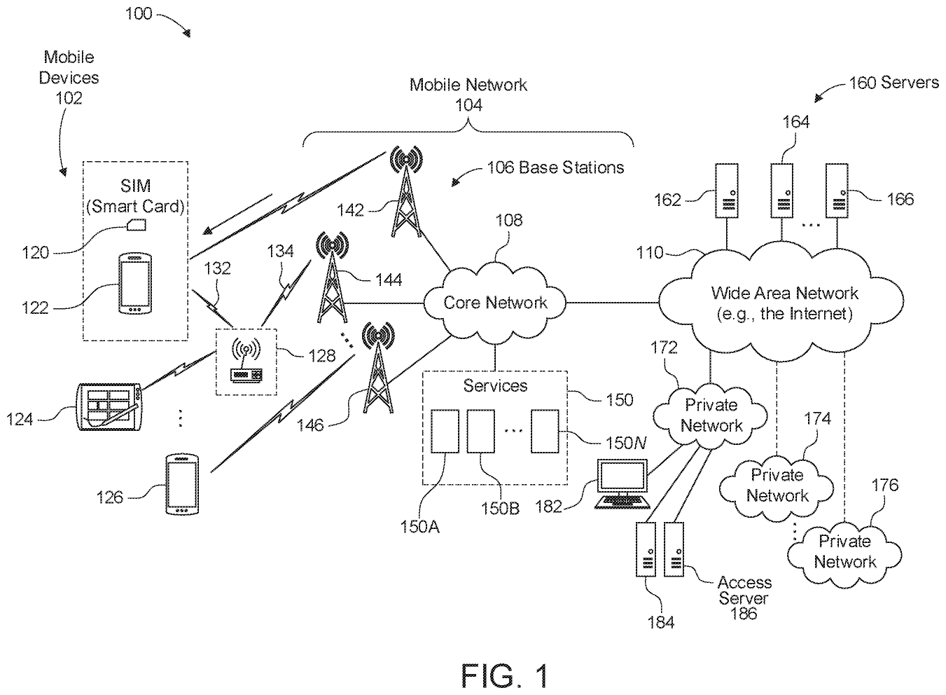

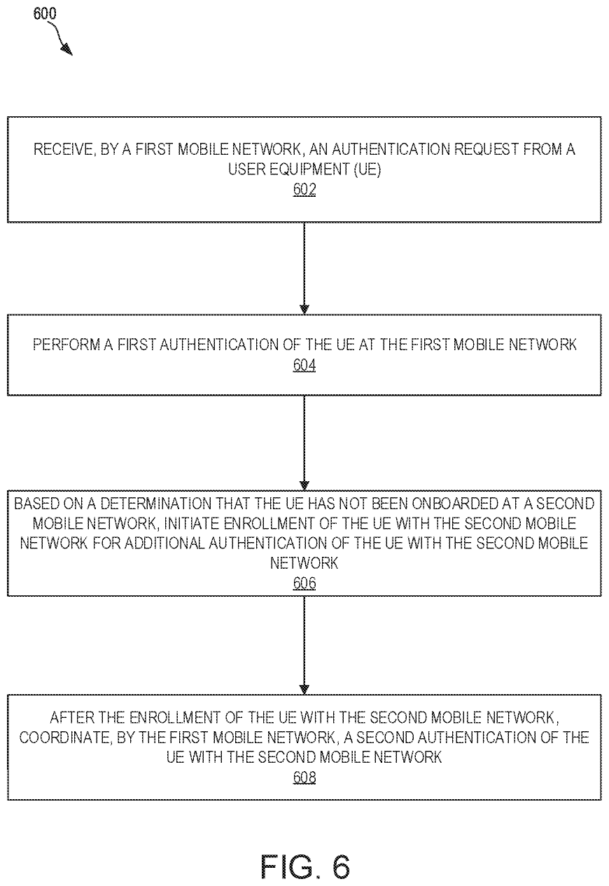

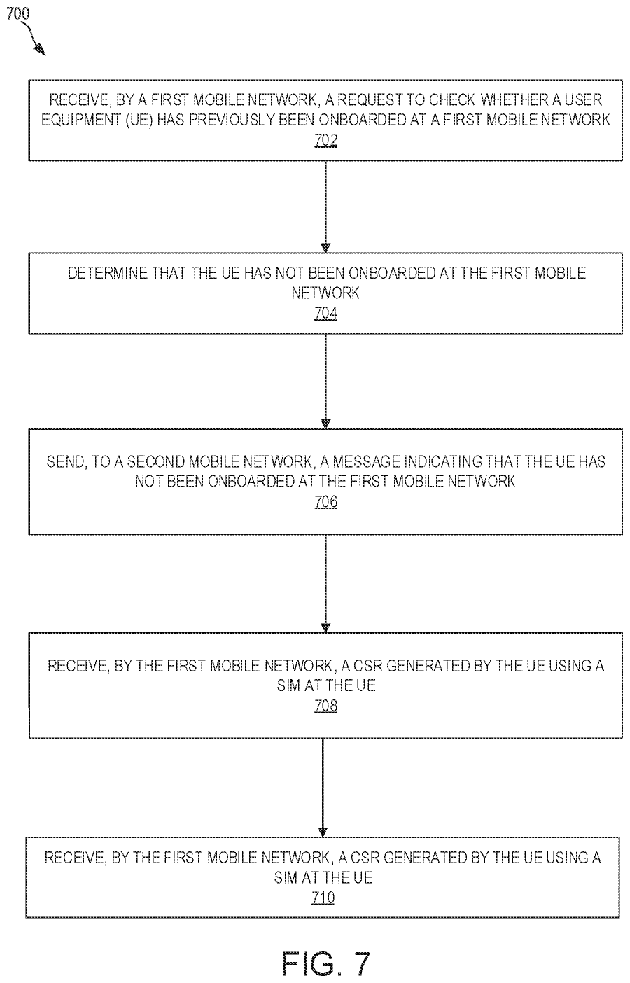

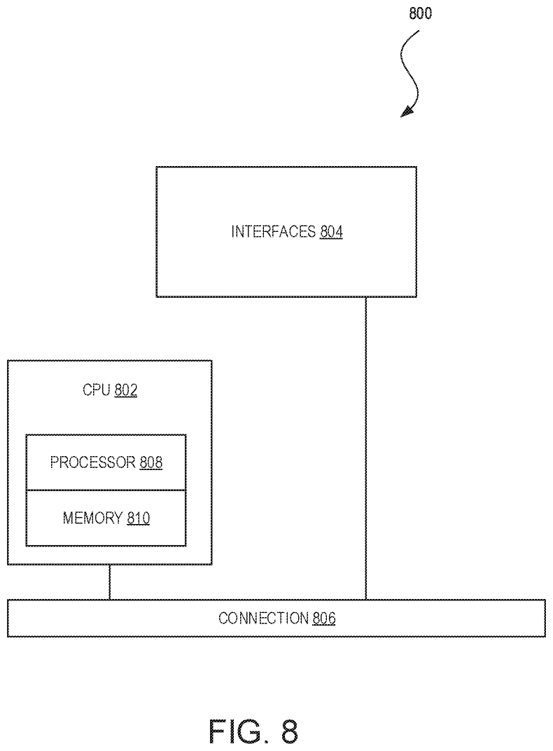

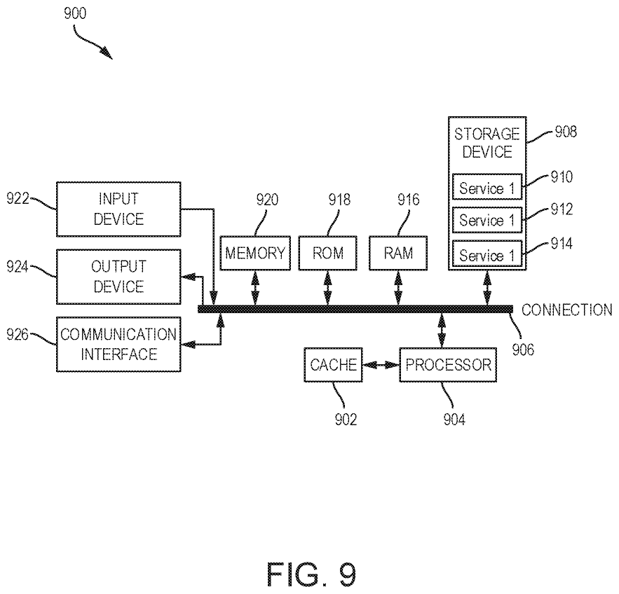

The present technology will be described in greater detail in the following disclosure. The discussion begins with a description of example mobile networks, systems and technologies for mobile communications and multi-factor authentication in mobile network environments, as illustrated in FIG. 1 through FIG. 5. A description of example methods for multi-factor authentication enrollment in mobile network environments, as illustrated in FIGS. 6 and 7, will then follow. The discussion concludes with a description of example network device and computing device architectures including example hardware components suitable for multi-factor authentication in mobile network environments, as illustrated in FIGS. 8 and 9. The disclosure now turns to FIG. 1.

FIG. 1 is a diagram of an example communication system 100 illustrating an example network environment in accordance with some examples of the present disclosure. While various relevant features are illustrated in FIG. 1 and other figures herein, those of ordinary skill in the art will appreciate from the present disclosure that various other features have not been illustrated for the sake of clarity and simplicity, and so as to not obscure various pertinent aspects of the examples and technologies disclosed herein.

The communication system 100 can include a mobile communication network (“mobile network”) 104. The mobile network 104 can include a wireless network, such as a wireless wide area network, a cellular telecommunications network (e.g., a 5G network, an LTE network, etc.), and the like. In some examples, the mobile network 104 can be connected to (e.g., can have connectivity to/with) one or more other networks such as, for example, a core network 108, a wide area network (WAN) 110 such as the Internet, one or more private networks 172-176, a cloud network (e.g., a private cloud network, a public cloud network, a hybrid cloud network), and/or any other networks.

In some examples, the WAN 110 can include one or more packet data networks. In some cases, one or more servers 160, such as servers 162, 164, and/or 166, can be connected to the WAN 110. The servers 160 can be configured to host data and/or provide network-based services accessible via the WAN 110.

The mobile network 104 can include one or more base stations 106, such as base stations 142, 144, and/or 146. The base stations 106 can be connected to a core network 108. In some examples, the mobile network 104 can be associated with a mobile network operator (MNO). Note that, although FIG. 1 illustrates a single mobile network 104 which can be associated with an MNO, in some cases, the communication system 100 can include additional mobile networks which can be associated with one or more other MNOs.

The communication system 100 can include mobile devices 102 used to communicate with the mobile network 104. In this example, the mobile devices 102 include user equipments (UEs) 122, 124, and 126. In other examples, the mobile devices 102 can include more or less mobile devices than shown in FIG. 1. The mobile devices 102 (and UEs 122, 124, 126) can communicate with the mobile network 104 through the base stations 106, such as base stations 142, 144, and/or 146. The mobile devices 102 (and UEs 122, 124, 126) can include any electronic devices with wireless capabilities such as, for example, cellular telephones, smartphones, laptop computers, tablet computers, smart wearable devices (e.g., smart watches, smart glasses, head-mounted displays, etc.), game systems, camera systems, autonomous systems and/or vehicles, personal digital assistants (PDAs), Internet-of-Things (IoT) devices, among others.

In some cases, one or more mobile devices, such as UE 128, can be equipped with multiple communication capabilities (e.g., cellular, WIFI, CBRS, etc.), and can operate as a mobile Access Point (AP) to provide a mobile “hotspot” for other communication devices. For example, the UE 128 can be incorporated in a system of a vehicle (e.g., a “connected car”) to provide a continuous hotspot in a mobile environment. In some cases, the UE 128 can be configured to provide wireless communications over a wireless connection 132 with another mobile device (e.g., UE 122), and provide wireless communications over a wireless connection 134 to the mobile network 104. In some examples, the wireless connection 132 between the UE 128 and another mobile device(s) can be based on one or more communication protocols such as, for example, one or more wireless local area network (WLAN) protocols (e.g., IEEE 802.11), CBRS or private LTE protocols, personal area network (PAN) protocols (e.g., ZIGBEE, BLUETOOTH, etc.), and the like.

The mobile devices 102 can use smart cards (e.g., Subscriber Identity Modules (SIMs)), such as smart card 120 (also referenced as SIM 120 herein), to connect to and/or communicate with the mobile network 104. For example, UE 122 can use smart card 120 to communicate with, and access services from, mobile network 104. In some examples, the smart card 120 can include a Subscriber Identity Module (SIM). In some cases, a SIM can include a microprocessor (e.g., a secure microprocessor) and/or software configured to execute on a microprocessor, which can be implemented by and/or embedded on a smart card, to provide a device with secure, identifiable, and authenticated access to a mobile network, such as mobile network 104. For instance, a SIM can securely store an International Mobile Subscriber Identity (IMSI) number and related key, which can be used to identify and authenticate a subscriber on a network. As another example, a SIM can securely store a signed certificate(s), which can be used to identify and authenticate a subscriber on a network.

In some cases, the smart card 120 can include a Universal Integrated Circuit Card (UICC) or an embedded UICC (eUICC). The smart card 120 can include a SIM that is and/or can be referred to as a Universal SIM (USIM), an IP Multimedia SIM (ISIM), a CDMA SIM (CSIM), an embedded SIM (eSIM), or the like. In some implementations, the SIM can be provided as a “soft SIM” where SIM software is embedded and running on a trusted, secure environment in the device itself. Although the description herein may indicate a specific implementation where the SIM is provided on a smart card/UICC, it should be understood and appreciated that the SIM may alternatively run in software or on its own silicon that is not part of a smart card/UICC.

In some examples, a SIM can be provisioned with one or more profiles. A profile can include operator data and/or applications to be provisioned for the purposes of providing identity, authentication, and/or other services to a device by a network operator. In some cases, a profile may be configured to enable communication and connectivity in support of a subscription which relates to a relationship between a subscriber and a service provider (e.g., the network operator or an associated third party).

In some examples, provisioning can include preparing and/or equipping a particular device and/or network so the device can receive and/or access services on the network. In some implementations, a provisioning of SIMs can conform to requirements of “Remote SIM Provisioning.” Remote SIM provisioning refers to a protocol for remote provisioning of a SIM in a device, described in one or more specifications developed by the Global System for Mobile Communications (GSM) Association.

The mobile network 104 can include various services 150. In the example shown in FIG. 1, the services 150 include services 150A through 150N. The services 150 (e.g., 150A through 150N) can include network elements, components, functions, nodes, servers, etc., to manage and/or provide network access, functionalities, connectivity, and/or any other capabilities. In some examples, the services 150 (e.g., 150A through 150N) can include some or all components of the system architecture evolution (SAE) defined by the 3^{rd} Generation Partnership Project (3GPP) LTE standard, such as one or more gateways (e.g., serving gateway, packet data network gateway, evolved packet data gateway, etc.), a mobility management entity (MME), a home subscriber server (HSS), etc. For example, in some cases, the services 150A through 150N can include an MME and an HSS. The MME can be configured to perform, handle and/or be involved in signaling, control plane functionalities, tracking and paging, authentication (e.g., by interacting with the HSS), one or more session management functions, etc. The HSS can be configured to perform, handle, and/or be involved in mobility management, call and session establishment support, user authentication, access authorization, user subscription services, etc.

In other examples, the services 150A through 150N can include network elements, components, functions, nodes, servers, etc., of a 5G network architecture. For example, in some cases, the services 150A through 150N can include an Access and Mobility Management Function (AMF); a Session Management Function (SMF), which can include a visited SMF (V-SMF) and/or a home SMF (H-SMF); a User Plane Function (UPF), which can include a visited UPF (V-UPF) and/or a home UPF (H-UPF); an authentication server function (AUSF); a SEcurity Anchor Function (SEAF); a Unified Data Management (UDM) function; and/or any other network elements, components, functions, nodes, servers, and/or the like.

In some examples, the services 150 can include a provisioning service (e.g., of a network operator) for provisioning profiles and a subscription manager (SM). The provisioning service and SM may be run by one or more operators and/or by one or more trusted third parties on behalf of one or more operators (e.g., a cloud provisioning service). An operator can include an operator and/or provider of a network, such as an MNO, and/or a trusted third party. In some cases, the provisioning service can be configured to facilitate the provisioning of SIMs to mobile devices for use and accessing and/or receiving services on the mobile network 104. The SM can be configured to prepare profiles of SIMs to be provisioned on smart cards of mobile devices. In some examples, the SM can be or include a Subscription Manager Data Preparation (SM-DP) function or module.

In some cases, smart card 120 and/or UE 122 may be owned and/or controlled by a user or subscriber, for example, for personal use. In other cases, smart card 120 and/or UE 122 may be owned and/controlled by an entity such as, for example, an enterprise or organization such as a business, institution, organization, etc. In such cases, the user or subscriber may be and/or be referred to as a member, an employee, a contractor, or a volunteer of the entity.

The communication system 100 can include one or more private communication networks, such as private communication networks 172, 174, and 176. In some examples, the private communication networks 172, 174, and/or 176 can include enterprise and/or on-premises networks owned, controlled, and/or operated by one or more private entities. The private communication networks 172, 174, and 176 can be connected to WAN 110. The private communication networks 172, 174, and/or 176 can include various devices such as, for example, computers or terminals (e.g. terminal 182), servers (e.g., servers 184 and 186), and/or any other electronic devices with networking capabilities.

In the example shown in FIG. 1, the private communication network 172 includes an access server 186 (also referred to herein as an enrollment server) configured to manage access (e.g., network enrollment, authentication, access restrictions, access provisioning, security, management and/or provisioning of digital certificates, etc.) to data and/or services in the private communication network 172. For example, the access server 186 can manage enrollment and/or authentication of devices based on one or more enrollment and/or authentication protocols and/or procedures, such as SIM-based (or eSIM based) authentication, certificate-based authentication, security key-based authentication, multi-factor authentication, authentication based on login credentials, authentication based on a challenge and response, and/or any other suitable authentication protocol and/or procedure.

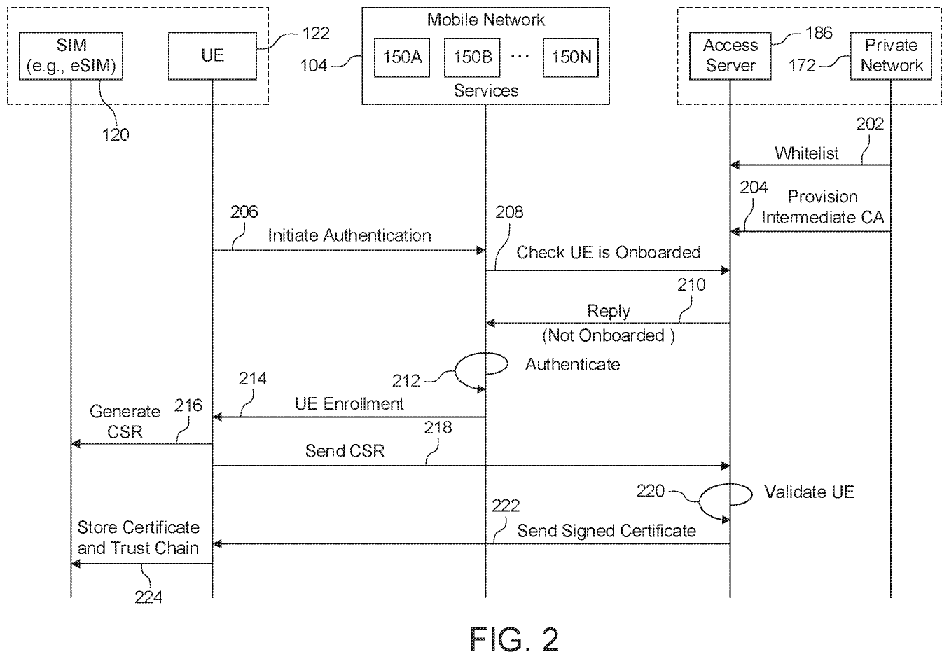

FIG. 2 is a diagram illustrating an example flow for UE multi-factor authentication enrollment. The UE multi-factor (e.g., multi-level, multi-layer, multi-authentication, etc.) authentication enrollment can be used to enroll a UE 122 for authentication with a private mobile network 172. The authentication with the private mobile network 172 can be part of a multi-factor authentication (e.g., multi-authentication procedure) performed by the UE 122 to authenticate with both a public mobile network and the private mobile network 172. For example, authentication with the private mobile network 172 can be part of a multi-factor authentication procedure performed by the UE 122 to authenticate with both the mobile network 104 and the private mobile network 172.

The multi-factor authentication procedure can allow the private mobile network 172 to verify UEs connecting to the private mobile network 172 and maintain control over a level or layer of authentication of the UEs connecting to the private mobile network 172. For example, rather than solely relying on the mobile network 104 to authenticate UEs connecting to the private mobile network 172, the private mobile network 172 can perform a second and/or separate authentication of UEs connecting to the private mobile network 172, to allow the private mobile network 172 to perform its own authentication of UEs connecting to the private mobile network 172. Accordingly, the UE multi-factor authentication enrollment shown in FIG. 2 and further described herein can enable the authentication of UEs by the private mobile network 172.

In this example, at 202, the private mobile network 172 can provision a whitelist of onboarded devices (and/or user identities) at the access server 186. The whitelist can identify any devices (and/or users) that have been onboarded at the private mobile network 172. For example, the whitelist can identify any devices (and/or users) that are allowed to access, and/or authenticate with, the private mobile network 172. In some cases, the whitelist can use a SIM credentials, such as SIM identifiers and/or digital certificates associated with SIMs, to identify whitelisted (e.g., onboarded) devices and/or users.

At 204, the private mobile network 172 can also provision an intermediate certificate authority (CA) at the access server 186. In some examples, as an intermediate CA, the access server 186 can issue digital certificates (e.g., X.509 certificates and the like) that certify the ownership of a public key by a named subject of a certificate (e.g., the SIM 120 and/or UE 122). The digital certificates allow other entities (and/or parties) to rely upon signatures and/or assertions made about a private key that corresponds to the certified public key. In some examples, as an intermediate CA, the access server 186 can act as a trusted party (e.g., trusted by the subject (owner) of the certificate and the party relying on the certificate).

At 206, the UE 122 can initiate authentication with the mobile network 104. In some examples, when enrolling for multi-factor authentication, the UE 122 can initiate the process at day zero, e.g., the first time the UE 122 tries to join the private network 172 before the UE 122 has any authentication credentials for the private network 172. In some examples, the UE 122 can send an authentication request to the mobile network 104 to initiate authentication with the mobile network 104. In some cases, the authentication request (and/or a subsequent message) can include information associated with the UE 122 and/or the SIM 120, such as a SIM credential (e.g., a SIM identifier, a digital certificate, a public key, etc.).

At 208, the mobile network 104 can check if the UE 122 has been onboarded at the private mobile network 172. For example, the mobile network 104 can send a message to the access server 186 asking if the UE 122 has been onboarded (and/or requesting information regarding the onboarding status of the UE 122). In some examples, the message can include information identifying the UE 122, such as a SIM credential (e.g., a SIM identifier, a digital certificate associated with the SIM 120, etc.), which the access server 186 can use to check the whitelist to determine if the UE 122 has been onboarded.

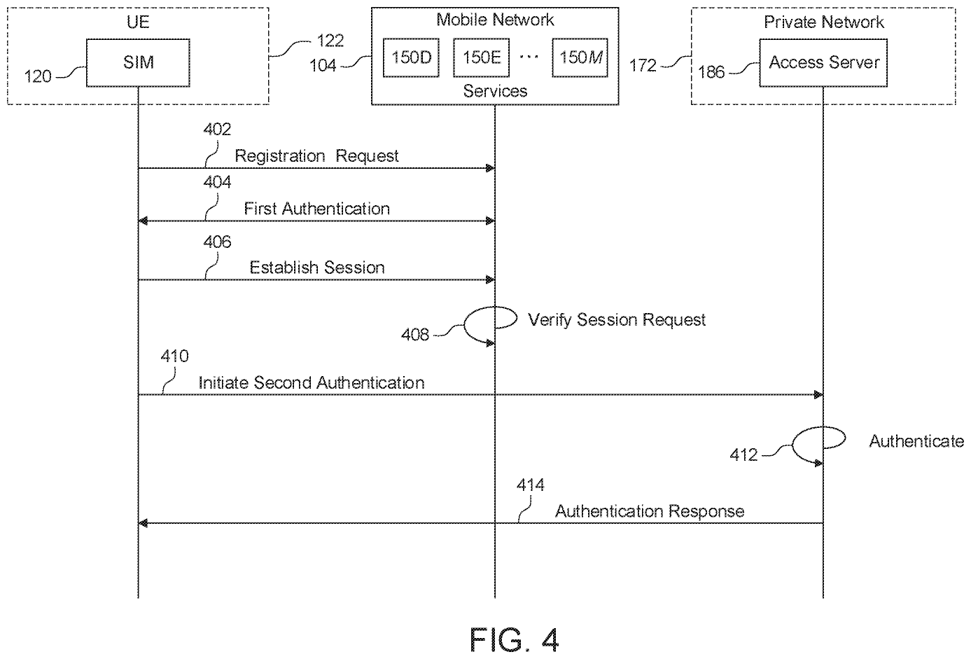

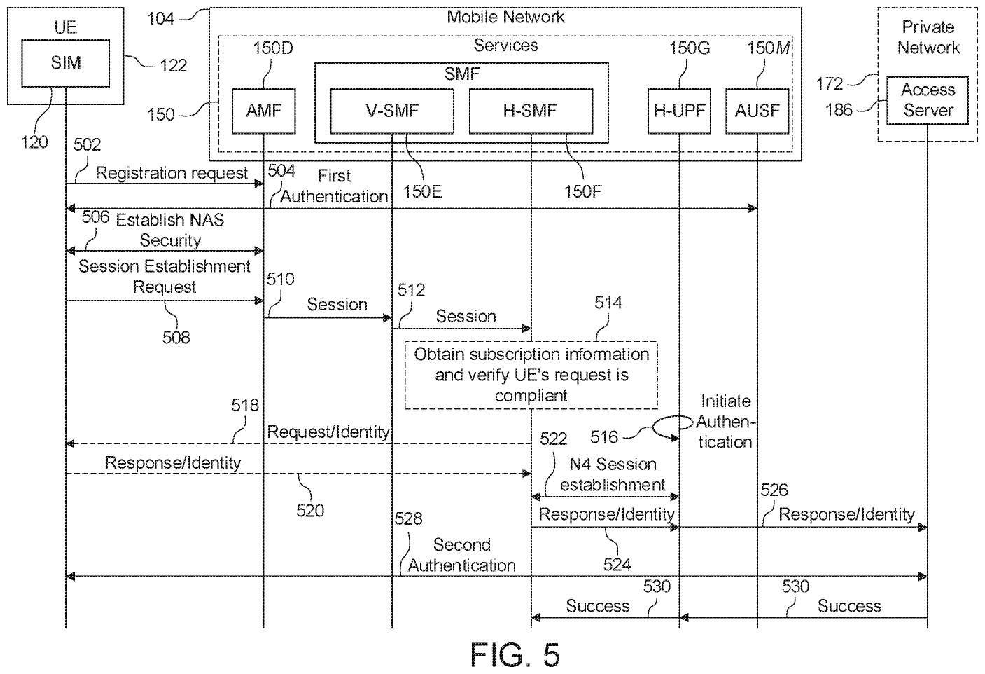

At 210, if the UE 122 has not been onboarded at the private mobile network 172, the access server 186 can send a reply to the mobile network 104 indicating that the UE 122 has not been onboarded at the private mobile network 172. For example, when replying to the mobile network 104, the access server 186 can check the whitelist to determine if the UE 122 is in the whitelist and determine that the UE 122 has not been onboarded if the UE 122 is not included in the whitelist. In other examples, if the UE 122 was previously onboarded, the access server 186 can inform the mobile network 172 that the UE 122 has been onboarded. In some cases, if the UE 122 has been onboarded, the UE 122 can perform a multi-factor and/or multi-authentication procedure as further described below with respect to FIGS. 4 and 5.

The mobile network 104 can receive the reply from the access server 186 and proceed with the multi-factor authentication enrollment. At 212, the mobile network 104 can authenticate the UE 122. The mobile network 104 can authenticate the UE 122 based on any authentication material such as, for example and without limitation, an authentication and key agreement (AKA), a certificate, a challenge/response, an authentication token, a password, one or more keys, a SIM credential, subscription information, and/or any other authentication material. In some examples, the mobile network 104 can authenticate the UE 122 based on a SIM credential, such as a SIM identifier, a public key, a certificate, and/or any other authentication information.

At 214, the mobile network 104 can start UE enrollment to enroll the UE 122 with the private mobile network 172 for authentication.

At 216, the UE 122 can coordinate with the SIM 120 to generate a certificate signing request (CSR). In some cases, prior to starting the enrollment and generating the CSR, the SIM 120 can represent an eSIM on the UE 122. In some examples, the UE 122 can obtain a network address (e.g., an Internet Protocol address) from the mobile network 104.

The CSR can include a message to the intermediate CA (e.g., the access server 186) applying for a digital identity certificate. In some examples, the CSR can include a public key associated with the SIM 120 (and/or the UE 122), a SIM identifier associated with the SIM 120, a digital certificate (e.g., an X.509 certificate) associated with the SIM 120, a digital signature, identifying information (e.g., a distinguished name or domain name, an organization name, an address, etc.), and/or any other CSR information.

In some cases, before creating the CSR, the UE 122 (and/or the SIM 120) can generate a key pair including a public key and a private key, and use the private key to sign the CSR and/or identifying information (e.g., a proof of identity) included in the CSR. The CSR can include the information identifying the UE 122 (and/or the SIM 120) and the public key. In some examples, the CSR can include a SIM credential (e.g., a SIM identifier, digital certificate, a public key, a digital signature, etc.), a token, identifying information, and/or any other CSR information.

At 218, the UE 122 can send the CSR to the access server 186. In some examples, the UE 122 can send the CSR to the access server 186 to authenticate with the access server 186, obtain a signed certificate from the access server 186, and/or be onboarded at the private mobile network 172.

At 220, the access server 186 can receive the CSR and validate the UE 122. In some examples, as the intermediate CA, the access server 186 can validate an identity of the UE 122 (and/or validity of the CSR) based on a public key in the CSR, a digital certificate (e.g., an X.509 certificate) in the CSR, a digital signature in the CSR, a SIM credential in the CSR, and/or any other CSR information. In some cases, the public key, digital certificate, digital signature, SIM credential, and/or other CSR information can be associated with the SIM 120. Once the UE 122 is validated, the access server 186 can also change a state of the UE 122 to onboarded. In some examples, the access server 186 can add the UE 122 (e.g., or information identifying the UE 122 such as a SIM identifier) to the whitelist of onboarded devices.

At 222, the access server 186 can generate and send a signed certificate to the UE 122. The access server 186 can generate and send the signed certificate based on the validation of the UE 122. The UE 122 can receive the signed certificate from the access server 186. At 224, the UE 122 can store the signed certificate and a trust chain. In some examples, the trust chain can include a certificate hierarchy, a list of certificates (e.g., a certificate associated with the SIM 120, a certificate associated with the access server 186, etc.), a trust anchor, and/or any other chain of trust information. The UE 122 can use the stored certificate to authenticate with the private mobile network 172 in a multi-factor and/or multi-authentication process as further described below with respect to FIGS. 4 and 5.

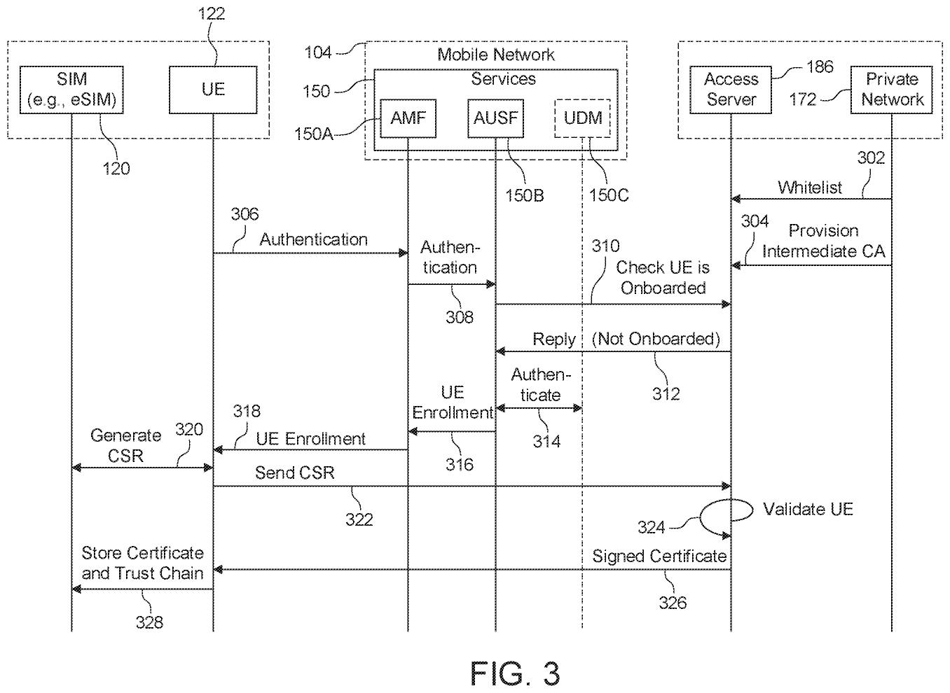

FIG. 3 is a diagram illustrating another example flow for UE multi-factor authentication enrollment in a mobile network environment including a public 5G network and a private mobile network. In this example, the mobile network 104 represents a 5G network and the UE multi-factor authentication enrollment is described in the context of the private mobile network 172 and the mobile network 104 implementing a 5G network architecture.

At 302, the private mobile network 172 can provision a whitelist of onboarded devices (and/or user identities) at the access server 186, as previously described. At 304, the private mobile network 172 can also provision the intermediate CA at the access server 186.

At 306, the UE 122 can initiate authentication with an AMF 150A at the mobile network 104. For example, the UE 122 can send an authentication request to the AMF 150A to initiate authentication with the mobile network 104. In some cases, the authentication request (and/or a subsequent message) can include authentication materials associated with the UE 122, such as a SIM credential (e.g., a SIM identifier, a digital certificate, a signature, a public key, etc.), a token, a password, and/or any other authentication credential.

At 308, the AMF 150A can initiate an authentication procedure with the AUSF 150B. In some examples, the AMF 150A can send an authentication request to the AUSF 150B. The authentication request can include information about the UE 122 such as, for example, an identity, subscription information, authentication materials (e.g., a SIM credential, a password, a token, etc.) associated with the UE 122 and/or the SIM 120, etc.

At 310, the AUSF 150B can check if the UE 122 has been onboarded at the private mobile network 172. For example, the AUSF 150B can send a message to the access server 186 asking if the UE 122 has been onboarded (and/or requesting information regarding the onboarding status of the UE 122). In some examples, the message can include information identifying the UE 122, such as a SIM credential (e.g., a SIM identifier, a digital certificate associated with the SIM 120, a digital signature, a password, a key, etc.), which the access server 186 can use to check the whitelist to determine if the UE 122 has been onboarded.

At 312, if the UE 122 has not been onboarded at the private mobile network 172, the access server 186 can send a reply to the AUSF 150B indicating that the UE 122 has not been onboarded at the private mobile network 172. For example, when replying to the AUSF 150B, the access server 186 can check the whitelist to determine if the UE 122 is in the whitelist, and determine that the UE 122 has not been onboarded if the UE 122 is not included in the whitelist. In other examples, if the UE 122 was previously onboarded, the access server 186 can inform the AUSF 150B that the UE 122 has been onboarded. In some cases, if the UE 122 has been onboarded, the UE 122 can perform a multi-factor and/or multi-authentication procedure as further described below with respect to FIGS. 4 and 5.

At 312, the AUSF 150B can receive the reply from the access server 186 and authenticate the UE 122. In some instances, the AUSF 150B can authenticate the UE 122 based on one or more authentication materials such as, for example, a SIM credential (e.g., a SIM identifier, a certificate, a public key, a signature, etc.), a token, an AKA, a password, and/or any other authentication credential. In some cases, the AUSF 150B can coordinate authentication of the UE 122 with a UDM 150C. For example, the AUSF 150B can send an authentication message to the UDM 150C. The authentication message can include an authentication request, a request for an authentication vector (AV), UE information, authentication materials, and/or any other information. The UDM 150C can generate an AV based on, for example and without limitation, one or more random values; an authentication token; a SIM credential; one or more keys associated with the UDM 150C, the AUSF 150B, and/or the UE 122; subscription information; and/or other information. The UDM 150C can provide an authentication response message to the AUSF 150B.

In some examples, the authentication response message can include the AV. In some cases, the authentication response message can include additional information such as, for example, a random number, an authentication token, an expected response, etc. In some examples, the AUSF 150B can additionally and/or alternatively generate an AV as described above. The AUSF 150B can generate other information such as one or more keys, a challenge and/or response, authentication material, etc.

At 316, after authenticating the UE 122, the AUSF 150B can start UE enrollment to enroll the UE 122 with the private mobile network 172 for authentication. In some examples, the AUSF 150B can send an authentication response to the AMF 150A indicating that the UE 122 has been successfully authenticated. The authentication response can start and/or trigger the UE enrollment. In some cases, the authentication response can include a UE identity, a challenge and/or response, authentication materials, and/or other information.

At 318, the AMF 150A can send a UE enrollment message to the UE 122 to initiate and/or trigger the UE enrollment. At 320, the UE 122 can coordinate with the SIM 120 to generate a CSR. In some examples, prior to starting the enrollment and/or generating the CSR, the UE 122 can obtain a network address (e.g., an Internet Protocol address) from the mobile network 104.

The CSR can include a message to the intermediate CA (e.g., the access server 186) applying for a digital identity certificate. In some examples, the CSR can include a public key associated with the SIM 120 (and/or the UE 122), a SIM identifier associated with the SIM 120, a digital certificate (e.g., an X.509 certificate) associated with the SIM 120, a digital signature, and/or identifying information (e.g., a distinguished name or domain name, an organization name, an address, etc.).

In some cases, before creating the CSR, the UE 122 (and/or the SIM 120) can generate a key pair including a public key and a private key, and use the private key to sign the CSR and/or identifying information (e.g., a proof of identity) included in the CSR. The CSR can include the information identifying the UE 122 (and/or the SIM 120) and the public key. In some examples, the CSR can include a SIM credential (e.g., a SIM identifier, a digital certificate, a public key, etc.), a digital signature, subscription information, identification information, and/or any other CSR information.

At 322, the UE 122 can send the CSR to the access server 186. In some examples, the UE 122 can send the CSR to the access server 186 to authenticate with the access server 186, obtain a signed certificate from the access server 186, and/or be onboarded at the private mobile network 172.

At 324, the access server 186 can receive the CSR and validate the UE 122. In some examples, as an intermediate CA, the access server 186 can validate an identity of the UE 122 (and/or validity of the CSR) based on a public key in the CSR, a proof of identity in the CSR, and/or a digital certificate (e.g., an X.509 certificate) in the CSR. The public key and/or digital certificate can be associated with the SIM 120 (and/or the UE 122). Once the UE 122 is validated, the access server 186 can change a state of the UE 122 to onboarded. In some examples, the access server 186 can add the UE 122 (e.g., information identifying the UE 122 such as a SIM identifier) to the whitelist of onboarded devices.

At 326, the access server 186 can generate and send a signed certificate to the UE 122. The access server 186 can generate and send the signed certificate based on the validation of the UE 122. The UE 122 can receive the signed certificate from the access server 186. At 328, the UE 122 can store the signed certificate and a trust chain. The UE 122 can use the stored certificate to authenticate with the private mobile network 172 in a multi-factor authentication process as further described below with respect to FIGS. 4 and 5.

The services 150A-C shown in FIG. 3 are example services provided for explanation purposes. One of ordinary skill in the art will recognize that, in other examples, the mobile network 104 can have a 5G architecture including more or less services and/or different services than shown in FIG. 3. Moreover, while the mobile network 104 in the example flow in FIG. 3 is shown as 5G network, in other examples, the mobile network 104 in the example flow in FIG. 3 can include a different mobile network architecture.

For example, the mobile network 104 can include an LTE network. To illustrate, in some cases, the mobile network 104 can implement an MME and an HSS. In such examples, the MME can initiate authentication and send the UE enrollment message as described above with respect to 306 and 318, and the HSS can initiate authentication, check if the UE 122 has been onboarded at the private mobile network 172, authenticate the UE 122, and start UE enrollment as previously described with respect to 308, 310, 314, and 316.

FIG. 4 is a diagram illustrating an example flow for multi-factor authentication (e.g., multi-layer and/or multi-level authentication, etc.) of a UE 122 in a public mobile network (e.g., mobile network 104) and a private mobile network (e.g., private mobile network 172). In some examples, the multi-factor authentication can be performed after the UE multi-factor authentication enrollment shown in FIG. 2 or 3 has completed. For example, the UE 122 can use the signed certificate obtained from the access server 186 in FIG. 2 or FIG. 3 to authenticate with the private mobile network 172 in the multi-factor authentication shown in FIG. 4.

At 402, the UE 122 can send a registration request to the mobile network 104 to initiate registration at the mobile network 104. In some examples, the UE 122 can provide a UE identity to the mobile network 104 with the registration request and/or in response to a subsequent request by the mobile network 104. In some cases, the UE 122 can provide the mobile network 104 other and/or additional information, such as authentication information.

At 404, the UE 122 and the mobile network 104 can coordinate a first authentication of the UE 122, to authenticate the UE 122 at the mobile network 104. In some examples, the mobile network 104 can authenticate the UE 122 based on one or more authentication materials such as, for example, a SIM credential (e.g., a SIM identifier, a digital certificate, a public key, a digital signature, etc.), a token, an AKA, a certificate, a challenge/response, a password, and/or any other authentication material. For example, the UE 122 can send an authentication request to the mobile network 104 including a SIM credential(s). The mobile network 104 can verify (e.g., validate, authorize, etc.) the SIM credential(s) and send an authentication response to the UE 122. If the mobile network 104 is able to verify the SIM credential(s), the authentication response can include an indication that the UE 122 has been successfully authenticated at the mobile network 104.

Once authenticated, at 406, the UE 122 can initiate establishment of a session at the mobile network 104. For example, the UE 122 can send a request to the mobile network 104 to establish a session with the mobile network 104, such as a packet data unit (PDU) session. At 408, the mobile network 104 can verify a session request from the UE 122 and establish the session for the UE 122. In some cases, the mobile network 104 can use subscription information to verify the session request from the UE 122.

At 410, the UE 122 can initiate a second authentication of the UE 122 with the access server 186. The second authentication can be an additional authentication procedure for the UE 122 to authenticate with the private mobile network 172. In some examples, the UE 122 can send an authentication request to the access server 186. In some cases, the authentication request can include a signed certificate obtained (and stored) by the UE 122 from the access server 186 as previously described with respect to FIG. 2 and FIG. 3.

At 412, the access server 186 can authenticate the UE 122. In some examples, the access server 186 can authenticate the UE 122 based on a signed certificate provided by the UE 122. The signed certificate can be a signed certificate previously obtained by the UE 122 from the access server 186 as previously described.

At 414, the access server 186 can send an authentication response to the UE 122. If the access server 186 was able to successfully authenticate the UE 122, the authentication response can indicate that the UE 122 has been successfully authenticated.

FIG. 5 is a diagram illustrating an example flow for multi-factor authentication (e.g., multi-layer and/or multi-level authentication, etc.) of a UE 122 in a network environment including a public 5G network and a private mobile network (e.g., private mobile network 172). In this example, the mobile network 104 can represent a public 5G network.

In some examples, the multi-factor authentication can be performed after the UE multi-factor authentication enrollment shown in FIG. 2 or 3 has completed. For example, the UE 122 can use the signed certificate obtained from the access server 186 in FIG. 2 or FIG. 3 to authenticate with the private mobile network 172 in the multi-factor authentication shown in FIG. 5.

At 502, the UE 122 can send a registration request to the AMF 150A to register with the mobile network 104. In some examples, the UE 122 can provide a UE identity to the mobile network 104 with the registration request and/or in response to a subsequent request by the mobile network 104. In some cases, the UE 122 can provide the mobile network 104 other and/or additional information, such as authentication information.

At 504, the UE 122 can perform a first authentication with the AUSF 150M. The UE 122 can authenticate with the AUSF 150M using its network access credentials such as, for example, a SIM credential, a password, etc. The first authentication can provide one level and/or layer of authentication in the multi-factor authentication of the UE 122.

At 506, the UE 122 can establish a non-access stratum (NAS) security context with the AMF 150D. At 508, the UE 122 can initiate establishment of a session at the mobile network 104. For example, the UE 122 can send a request to the AMF 150D to establish a session with the mobile network 104, such as a packet data unit (PDU) session. In some cases, the request can include slice information, session information (e.g., a session identifier), session management information, etc.

At 510, the AMF 150D can select the V-SMF 150E and send the V-SMF 150E a request to create a session and/or context for the UE 122. In some examples, the request can include one or more subscription identifiers, such as a Subscription Permanent Identifier (SUPI), for example. In some examples, the V-SMF 150E can then send a corresponding response to the AMF 150D.

At 512, the V-SMF 150E can send a session request to the H-SMF 150F. In cases involving a single SMF in the session setup (e.g., in non-roaming or local breakout cases), the single SMF can take the role of the V-SMF 150E and the H-SMF 150F.

At 514, the H-SMF 150F can obtain subscription information for one or more subscription identifiers (e.g., a SUPI, etc.) obtained from the AMF 150D and verify that the session request from the UE 122 is compliant. For example, the H-SMF 150F can check the subscription information and determine whether the UE 122 is to perform a second authentication, whether the session request from the UE 122 is allowed according to user subscription and local policies, etc. In some cases, the H-SMF 150F can obtain the subscription information from a UDM and/or any other component.

In this example, the H-SMF 150F can determine that the UE 122 is to perform a second authentication. At step 516, the H-SMF 150F can initiate a second authentication with the private mobile network 172. At step 518, the H-SMF 150F can request an identity from the UE 122. At step 520, the UE 122 can send a response to the H-SMF 150F including a UE identity. In some cases, the UE 122 can provide the identity with the registration request at 502 and/or the session request at 508, in which case the identity request and response at 518 and 520 may be skipped.

At 522, if an N4 session has not been established, the H-SMF 150F can select the H-UPF 150G and establish an N4 session with the H-UPF 150G. At 524, the H-SMF 150F can provide the UE identity to the H-UPF 150G. At 526, the H-UPF 150G can forward the UE identity to the access server 186.

At 528, the access server 186 and the UE 122 can perform a second authentication to authenticate the UE 122 at the private mobile network 172. The UE 122 can authenticate with the private mobile network 172 (via the access server 186) using the signed certificate previously obtained from the access server 186 as described above with respect to FIG. 2 and FIG. 3. In some examples, the UE 122 and the access server 186 can exchange one or more authentication messages as part of the second authentication. For example, the UE 122 can send to the access server 186 the signed certificate and the access server 186 can send to the UE 122 an authentication response and/or other authentication messages.

In some examples, at 530, the access server 186 can send a message to the H-SMF 150F indicating that the second authentication was successful. At this point, the UE 122 has successfully performed the multi-factor authentication to authenticate with both the mobile network 104 and the private mobile network 172. In some cases, if additional there are remaining steps for establishing the session between the UE 122 and the mobile network 104, the UE 122 and mobile network 104 can proceed with any additional steps for establishing the session between the UE 122 and the mobile network 104.

The services 150D-M shown in FIG. 5 are example services provided for explanation purposes. One of ordinary skill in the art will recognize that, in other examples, the mobile network 104 can have a 5G architecture including more or less services and/or different services than shown in FIG. 5. Moreover, while the mobile network 104 in the example flow in FIG. 5 is shown as 5G network, in other examples, the mobile network 104 in the example flow in FIG. 5 can include a different mobile network architecture.

For example, the mobile network 104 can include an LTE network including an MME and an HSS for facilitating the various steps described in FIG. 5 with respect to the mobile network 104. To illustrate, the MME and HSS can implement control plane and authentication functionalities to facilitate the multi-factor authentication of the UE 122, as described above.

FIG. 6 is a flowchart illustrating an example method 600 for UE multi-factor authentication enrollment. At block 602, the method 600 can include receiving, by a first mobile network (e.g., mobile network 104), an authentication request from a UE (e.g., UE 122). In some examples, the authentication request can include information associated with the UE, such as a UE identity (e.g., a profile, a SIM identifier, etc.) and/or UE authentication credentials (e.g., a SIM credential, a token, a password, a key, etc.).

At block 604, the method 600 can include performing a first authentication of the UE at the first mobile network. For example, the first mobile network can authenticate the UE in response to the authentication request. In some cases, the first mobile network can authenticate the UE based on a SIM credential (e.g., a SIM identifier, a digital signature, a certificate, etc.), a password, a token, an AKA, one or more keys, a proof-of-identity, and/or any other authentication credential.

At block 606, the method 600 can include, based on a determination that the UE has not been onboarded at a second mobile network (e.g., private mobile network 172), initiating, by the first mobile network, enrollment of the UE with the second mobile network for additional authentication (e.g., a second authentication) of the UE with the second mobile network. In some examples, the first mobile network can send to the second mobile network a request to check whether the UE has been previously onboarded at the second mobile network. The first mobile network can determine whether the UE has been previously onboarded based on a response from the second mobile network.

In some examples, the first mobile network and the second mobile network can be separate networks. For example, the first network and the second mobile network can be different networks owned, operated and/or hosted by separate entities. As another example, the first network and the second network can have and/or implement different authentication domains and/or authentication management systems. In some cases, the first mobile network can include a public mobile network and/or one or more cloud-hosted mobile services, and the second mobile network can include a private mobile network.

In some cases, the method 600 can perform the first authentication at block 604 after initiating the enrollment at block 606. In other cases, the method 600 can perform the first authentication at block 604 before initiating the enrollment at block 606.

In some cases, initiating the enrollment of the UE with the second mobile network can include sending, by the first mobile network to the UE, a message triggering the UE to generate a certificate signing request (CSR) for the second mobile network using an eSIM (e.g., SIM 120) associated with the UE. In some examples, the message can indicate to the UE that the UE is not onboarded (e.g., enrolled) at the second mobile network.

At block 608, the method 600 can include, after the enrollment of the UE with the second mobile network, coordinating, by the first mobile network, a second authentication of the UE with the second mobile network.

In some aspects, the method 600 can include, in response to the authentication request, sending, by the first mobile network to the second mobile network, a request to check whether the UE has previously been onboarded at the second mobile network; receiving, by the first mobile network, a first message indicating that the UE has not been onboarded at the second mobile network; and sending, by the first mobile network to the UE, a second message triggering the enrollment of the UE with the second mobile network.

In some aspects, the method 600 can include coordinating the enrollment of the UE with the second mobile network. In some examples, coordinating the enrollment of the UE can include receiving, by the first mobile network from the UE, a CSR generated by the UE using an eSIM (e.g., SIM 120); and forwarding, by the first mobile network to the second mobile network, the CSR from the UE. In some cases, coordinating the enrollment of the UE can include receiving, by the first mobile network from the second mobile network, a signed certificate associated with the CSR from the UE; and forwarding, by the first mobile network, the signed certificate to the UE.

In some cases, coordinating the second authentication of the UE with the second mobile network can include sending, by the first mobile network to the second mobile network, a message including an identity associated with the UE (e.g., a UE identity, a SIM identifier, etc.); forwarding, by the first mobile network to the second mobile network, a CSR generated by the UE using an eSIM at the UE; and forwarding, by the first mobile network to the UE, a signed certificate from the second mobile network. The signed certificate can be associated with the CSR. For example, the signed certificate can be generated based on the CSR. In some examples, the message including the identity associated with the UE can be sent after the UE has been authenticated at the first mobile network and/or enrolled (e.g., onboarded) at the second mobile network.

In some aspects, the method 600 can include receiving, by the first mobile network, a registration request from the UE; authenticating the UE at the first mobile network; determining that the UE has been onboarded at the second mobile network; and based on the UE being onboarded at the second mobile network, coordinating, by the first mobile network, a separate authentication of the UE with the second mobile network. In some examples, the UE can be onboarded based on the enrollment of the UE with the second mobile network.

In some examples, coordinating the separate authentication of the UE can include obtaining an identity associated with the UE and sending the identity to the second mobile network.

FIG. 7 is a flowchart illustrating another example method 700 for UE multi-factor authentication enrollment. At block 702, the method 700 can include receiving, by a first mobile network (e.g., private mobile network 176), a request to check whether a UE (e.g., UE 122) has previously been onboarded at a first mobile network.

At block 704, the method 700 can include determining, by the first mobile network, that the UE has not been onboarded at the first mobile network. In some examples, the first mobile network can check a whitelist of onboarded device to determine if the UE has been onboarded. If the UE is not included in the whitelist, the first mobile network can determine that the UE has not been onboarded. In some cases, the first mobile network can check the whitelist for inclusion of a UE identity and/or an eSIM identifier to determine if the UE has been onboarded. The UE identity and/or the eSIM identifier can correspond to an eSIM at the UE.

In some aspects, the method 700 can include provisioning the whitelist at the first mobile network. For example, the first mobile network can provision a whitelist of onboarded devices at an authentication server, such as access server 186. In some cases, the method 700 can include provisioning an intermediate CA at the authentication server (e.g., the access server 186).

At block 706, the method 700 can include sending, to a second mobile network (e.g., mobile network 104), a message indicating that the UE has not been onboarded at the first mobile network.

At block 708, the method 700 can include receiving, by the first mobile network, a CSR generated by the UE using an eSIM (e.g., SIM 120) at the UE. In some examples, the CSR can include a key generated by the eSIM, an identifier associated with the eSIM, a digital certificate at the eSIM, and/or UE information.

At block 710, the method 700 can include, in response to validating the CSR, generating, by the first mobile network, a signed certificate for the UE. The signed certificate can be generated based on the CSR and/or one or more portions of the CSR such as, for example, a key in the CSR, a digital certificate in the CSR, an eSIM credential in the CSR, a UE identity in the CSR, etc. In some cases, the first mobile network can validate the CSR based on an eSIM credential in the CSR (e.g., an eSIM identifier, a key, a certificate, etc.), a token, a password, a proof-of-identity, UE information in the CSR, and/or any other information in the CSR.

In some aspects, the method 700 can include sending the signed certificate to the UE for authentication with the first mobile network. The UE can use the signed certificate to perform multi-factor authentication as described herein. For example, the UE can use the signed certificate to authenticate with the first mobile network in addition to authenticating with the second mobile network.

In some examples, the first mobile network and the second mobile network can be separate mobile networks and/or can implement different authentication domains and/or authentication systems. In some cases, the first mobile network can include a private mobile network and the second mobile network can include a public mobile network and/or one or more cloud-hosted mobile services.

The disclosure now turns to FIGS. 8 and 9, which illustrate example network devices and computing devices, such as switches, routers, nodes, servers, client devices, orchestrators, and so forth.

FIG. 8 illustrates an example network device 800 suitable for performing switching, routing, authentication, and other networking operations. Network device 800 includes a central processing unit (CPU) 804, interfaces 802, and a bus 810 (e.g., a PCI bus). When acting under the control of appropriate software or firmware, the CPU 804 is responsible for executing packet management, error detection, and/or routing functions. The CPU 804 preferably accomplishes all these functions under the control of software including an operating system and any appropriate applications software. CPU 804 may include one or more processors 808, such as a processor from the INTEL X86 family of microprocessors. In some cases, processor 808 can be specially designed hardware for controlling the operations of network device 800. In some cases, a memory 806 (e.g., non-volatile RAM, ROM, etc.) also forms part of CPU 804. However, there are many different ways in which memory could be coupled to the system.

The interfaces 802 are typically provided as modular interface cards (sometimes referred to as “line cards”). Generally, they control the sending and receiving of data packets over the network and sometimes support other peripherals used with the network device 800. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master CPU (e.g., 804) to efficiently perform routing computations, network diagnostics, security functions, etc.

Although the system shown in FIG. 8 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 800.

Regardless of the network device's configuration, it may employ one or more memories or memory modules (including memory 806) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 806 could also hold various software containers and virtualized execution environments and data.

The network device 800 can also include an application-specific integrated circuit (ASIC), which can be configured to perform routing and/or switching operations. The ASIC can communicate with other components in the network device 800 via the bus 810, to exchange data and signals and coordinate various types of operations by the network device 800, such as routing, switching, and/or data storage operations, for example.

FIG. 9 illustrates an example computing system architecture 900 of a computing device which can be used to perform authentication procedures, enrollment procedures, and/or any other computing operations described herein. For example, a computing device with the computing system architecture 900 can perform the method 600 shown in FIG. 6 and/or the method 700 shown in FIG. 7. The computing device with the computing system architecture 900 can include any electronic computing device such as, for example, a personal computer, a smartphone, a server, an Internet-of-Things (IoT) device, a cellular phone, an autonomous vehicle, a drone, a smart wearable device, a network device, a user terminal, a cellular system, and/or any other electronic device with networking capabilities.

In this example, the components of the system 900 are in electrical communication with each other using a connection 906, such as a bus. The system 900 includes a processing unit (CPU or processor) 904 and a connection 906 that couples various system components including a memory 920, such as read only memory (ROM) 918 and random access memory (RAM) 916, to the processor 904.

The system 900 can include a cache of high-speed memory connected directly with, in close proximity to, or integrated as part of the processor 904. The system 900 can copy data from the memory 920 and/or the storage device 908 to cache 902 for quick access by the processor 904. In this way, the cache can provide a performance boost that avoids processor 904 delays while waiting for data. These and other modules can control or be configured to control the processor 904 to perform various actions. Other memory 920 may be available for use as well. The memory 920 can include multiple different types of memory with different performance characteristics. The processor 904 can include any general purpose processor and a hardware or software service, such as service 1 910, service 2 912, and service 3 914 stored in storage device 908, configured to control the processor 904 as well as a special-purpose processor where software instructions are incorporated into the actual processor design. The processor 904 may be a completely self-contained computing system, containing multiple cores or processors, a bus, memory controller, cache, etc. A multi-core processor may be symmetric or asymmetric.

To enable user interaction with the computing system 900, an input device 922 can represent any number of input mechanisms, such as a microphone for speech, a touch-sensitive screen for gesture or graphical input, keyboard, mouse, motion input, speech and so forth. An output device 924 can also be one or more of a number of output mechanisms known to those of skill in the art. In some instances, multimodal systems can enable a user to provide multiple types of input to communicate with the computing system 900. The communications interface 926 can generally govern and manage the user input and system output. There is no restriction on operating on any particular hardware arrangement and therefore the basic features here may easily be substituted for improved hardware or firmware arrangements as they are developed.

Storage device 908 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 916, read only memory (ROM) 918, and hybrids thereof.

The storage device 908 can include services 910, 912, 914 for controlling the processor 904. Other hardware or software modules are contemplated. The storage device 908 can be connected to the connection 906. In one aspect, a hardware module that performs a particular function can include the software component stored in a computer-readable medium in connection with the necessary hardware components, such as the processor 904, connection 906, output device 924, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

What is claimed is:

1. A method comprising:
receiving, by a first mobile network, an authentication request from a user equipment (UE);
performing a first authentication of the UE at the first mobile network;
based on a determination that the UE has not been onboarded at a second mobile network, initiating, by the first mobile network, enrollment of the UE with the second mobile network for additional authentication of the UE with the second mobile network, wherein the first mobile network is separate from the second mobile network; and
after the enrollment of the UE with the second mobile network, coordinating, by the first mobile network, a second authentication of the UE with the second mobile network.

2. The method of claim 1, wherein initiating the enrollment of the UE with the second mobile network comprises sending, by the first mobile network to the UE, a message triggering the UE to generate a certificate signing request (CSR) for the second mobile network using an embedded subscriber identity module (eSIM) associated with the UE.

3. The method of claim 1, further comprising:
in response to the authentication request, sending, by the first mobile network to the second mobile network, a request to check whether the UE has previously been onboarded at the second mobile network;
receiving, by the first mobile network, a first message indicating that the UE has not been onboarded at the second mobile network; and
sending, by the first mobile network to the UE, a second message triggering the enrollment of the UE with the second mobile network.

4. The method of claim 1, further comprising coordinating the enrollment of the UE with the second mobile network, wherein coordinating the enrollment of the UE comprises:
receiving, by the first mobile network from the UE, a certificate signing request (CSR) generated by the UE using an embedded subscriber identity module (eSIM); and
forwarding, by the first mobile network to the second mobile network, the CSR from the

5. The method of claim 4, wherein coordinating the enrollment of the UE further comprises:
receiving, by the first mobile network from the second mobile network, a signed certificate associated with the CSR from the UE; and
forwarding, by the first mobile network, the signed certificate to the UE.

6. The method of claim 1, wherein coordinating the second authentication of the UE with the second mobile network comprises:
sending, by the first mobile network to the second mobile network, a message including an identity associated with the UE, the message being sent after the UE has been authenticated at the first mobile network;
forwarding, by the first mobile network to the second mobile network, a certificate signing request (CSR) generated by the UE using an embedded subscriber identity module (eSIM); and
forwarding, by the first mobile network to the UE, a signed certificate from the second mobile network, the signed certificate being associated with the CSR.

7. The method of claim 1, further comprising:
receiving, by the first mobile network, a registration request from the UE;
authenticating the UE at the first mobile network;
determining that the UE has been onboarded at the second mobile network, the UE being onboarded based on the enrollment of the UE with the second mobile network; and
based on the UE being onboarded at the second mobile network, coordinating, by the first mobile network, a separate authentication of the UE with the second mobile network.

8. The method of claim 7, wherein coordinating the separate authentication of the UE comprises obtaining an identity associated with the UE and sending the identity to the second mobile network.

9. The method of claim 1, wherein the first mobile network comprises a public mobile network and the second mobile network comprises a private mobile network, wherein the first mobile network and the second mobile network implement at least one of different authentication domains and different authentication management systems.

10. A system comprising:
one or more processors; and
at least one non-transitory computer-readable medium having stored thereon instructions which, when executed by the one or more processors, cause the one or more processors to:
receive, at a first mobile network, an authentication request from a user equipment (UE);
perform a first authentication of the UE at the first mobile network;
based on a determination that the UE has not been onboarded at a second mobile network, initiate, by the first mobile network, enrollment of the UE with the second mobile network for additional authentication of the UE with the second mobile network, wherein the first mobile network is separate from the second mobile network; and
after the enrollment of the UE with the second mobile network, coordinate, by the first mobile network, a second authentication of the UE with the second mobile network.

11. The system of claim 10, wherein initiating the enrollment of the UE with the second mobile network comprises sending, by the first mobile network to the UE, a message triggering the UE to generate a certificate signing request (CSR) for the second mobile network using an embedded subscriber identity module (eSIM) associated with the UE.

12. The system of claim 10, wherein the at least one non-transitory computer-readable medium comprises instructions which, when executed by the one or more processors, cause the one or more processors to:
in response to the authentication request, send, by the first mobile network to the second mobile network, a request to check whether the UE has previously been onboarded at the second mobile network;
receive, by the first mobile network, a first message indicating that the UE has not been onboarded at the second mobile network; and
send, by the first mobile network to the UE, a second message triggering the enrollment of the UE with the second mobile network.

13. The system of claim 10, wherein the at least one non-transitory computer-readable medium comprises instructions which, when executed by the one or more processors, cause the one or more processors to coordinate the enrollment of the UE with the second mobile network, wherein coordinating the enrollment of the UE comprises:
receiving, by the first mobile network from the UE, a certificate signing request (CSR) generated by the UE using an embedded subscriber identity module (eSIM); and
forwarding, by the first mobile network to the second mobile network, the CSR.

14. The system of claim 13, wherein coordinating the enrollment of the UE further comprises:
receiving, by the first mobile network from the second mobile network, a signed certificate associated with the CSR from the UE; and
forwarding, by the first mobile network, the signed certificate to the UE.

15. The system of claim 10, wherein coordinating the second authentication of the UE with the second mobile network comprises:
sending, by the first mobile network to the second mobile network, a message including an identity associated with the UE, the message being sent after the UE has been authenticated at the first mobile network;
forwarding, by the first mobile network to the second mobile network, a certificate signing request (CSR) generated by the UE using an embedded subscriber identity module (eSIM); and
forwarding, by the first mobile network to the UE, a signed certificate from the second mobile network, the signed certificate being associated with the CSR.

16. The system of claim 10, wherein the at least one non-transitory computer-readable medium comprises instructions which, when executed by the one or more processors, cause the one or more processors to:
receive, by the first mobile network, a registration request from the UE;
authenticate the UE at the first mobile network;
determine that the UE has been onboarded at the second mobile network, the UE being onboarded based on the enrollment of the UE with the second mobile network; and
based on the UE being onboarded at the second mobile network, coordinate, by the first mobile network, a separate authentication of the UE with the second mobile network.

17. The system of claim 16, wherein coordinating the separate authentication of the UE comprises obtaining an identity associated with the UE and sending the identity to the second mobile network.

18. The system of claim 10, wherein the first mobile network comprises a public mobile network and the second mobile network comprises a private mobile network, wherein the first mobile network and the second mobile network implement at least one of different authentication domains and different authentication management systems.

19. At least one non-transitory computer-readable medium comprising instructions which, when executed by one or more processors, cause the one or more processors to:
receive, at a first mobile network, an authentication request from a user equipment (UE);
perform a first authentication of the UE at the first mobile network;
based on a determination that the UE has not been onboarded at a second mobile network, initiate, by the first mobile network, enrollment of the UE with the second mobile network for additional authentication of the UE with the second mobile network, wherein the first mobile network is separate from the second mobile network; and
after the enrollment of the UE with the second mobile network, coordinate, by the first mobile network, a second authentication of the UE with the second mobile network.

20. The at least one non-transitory computer-readable medium of claim 19, wherein initiating the enrollment of the UE with the second mobile network comprises sending, by the first mobile network to the UE, a message triggering the UE to generate a certificate signing request (CSR) for the second mobile network using an embedded subscriber identity module (eSIM) associated with the UE.
